(19) United States
(12) Patent Application Publication
(10) Pub. No.: US 2025/0019255 A1
(43) Pub. Date: Jan. 16, 2025

(54) Method and system for producing molybdenum disulfide inorganic nanotubes

(71) Applicant: A.Y.Y.T. - Technological Applications and Data Update Ltd., Holon (IL)

(72) Inventors: Alla ZAK, Rehovot (IL); Saptarshi GHOSH, Madhyamgram, Kolkata (IN); Manjunath KRISHNAPPA, Andhra Pradesh (IN); Chithaiah PALLELLAPPA, Karnataka (IN); Yishay FELDMAN, Rehovot (IL); Maya BAR-SADAN, Rehovot (IL)

(21) Appl. No.: 18/352,891

(22) Filed: Jul. 14, 2023

Related U.S. Application Data
(63) Continuation-in-part of application No. 17/300,330, filed on Jun. 20, 2023.

(51) Int. Cl. C01G 39/06; B82Y 30/00; B82Y 40/00

(52) U.S. Cl. CPC C01G 39/06; B82Y 30/00; B82Y 40/00; C01P 2002/10; C01P 2002/72; C01P 2004/13; C01P 2004/64

(57) ABSTRACT

Method is presented for crystalline molybdenum disulfide (MoS₂) inorganic nanotubes (INTs) production. Initial synthesis of pure phase hexagonal molybdenum oxide (h-MoO₃) nanowhiskers is performed forming precursor and templating agent for MoS₂ INTs production. First-stage sulfurization of h-MoO₃ is performed via a solid-gas reaction at first temperature conditions T₁ producing MoOₓ-containing nanowhiskers (2≤x<3) followed by formation of initial growth stage of MoS₂ INTs being nanostructures having cores with MoOₓ-containing nanowhiskers and initial MoS₂ intermittent guiding layers being randomly oriented nanoplatelets or partially distorted layers at surface of MoOₓ-containing nanowhiskers. Second or successive second and third stages of sulfurization of said nanostructures is/are performed providing recrystallization of MoS₂ intermittent guiding layers to obtain highly crystalline layers and complete sulfurization of MoOₓ inside the cores to MoS₂, and obtain pure phase and high aspect ratio MoS₂ INTs of needle-like crystal with hollow core morphology, and predetermined walls' structure.

### TECHNOLOGICAL FIELD

The invention is generally in the field of production of inorganic nanotubes, and relates to a method and system for molybdenum disulfide nanotubes production.

### BACKGROUND ART

References considered to be relevant as background to the presently disclosed subject matter are listed below:
1. S. Ghosh, V. Bruser, I. Kaplan-Ashiri, R. Popovitz-Biro, S. Peglow, J. I. Martinez, J. A. Alonso, A. Zak, Cathodoluminescence in single and multiwall WS₂ nanotubes: Evidence for quantum confinement and strain effect. Applied Physics Reviews 2020, 7, 041401.
2. (a) K. F. Mak, C. Lee, J. Hone, J. Shan, and T. F. Heinz, Atomically thin MoS₂: a new direct-gap semiconductor, Phys. Rev. Lett. 105, 136805 (2010); (b) A. Splendiani, L. Sun, Y. Zhang, T. Li, J. Kim, C.-Y. Chim, G. Galli, F. Wang, Emerging Photoluminescence in Monolayer MoS₂, Nano Lett. 10, 1271 (2010).
3. (a) A. Kuc, N. Zibouche, and T. Heine, Influence of quantum confinement on the electronic structure of the transition metal sulfide TS₂, Phys. Rev. B 83, 245213 (2011). (b) W. Zhao, Z. Ghorannevis, L. Chu, M. Toh, C. Kloc, P.-H. Tan, and G. Eda, Evolution of Electronic Structure in Atomically Thin Sheets of WS₂ and WSe₂, ACS
Nano 7, 791 (2013). 4. C. N. R. Rao, R. Voggu, A. Govindaraj. Selective generation of single-walled carbon nanotubes with metallic, semiconducting and other unique electronic properties. Nanoscale 2009, 1, 96-105.
5. G. Hwang, Y. Kwon, J. Lee, Y. Jeong, Enhanced mechanical and anisotropic thermal conductive properties of polyimide nanocomposite films reinforced with hexagonal boron nitride nanosheets. J. Appl. Polym. Sci. 2020, 138, 50324.
6. L. Zheng, Z. Liu, D. Liu, X. Wang, Y. Li, M. Jiang, F. Lin, H. Zhang, B. Shen, X. Zhu, Y. Gong, Z. Fang, Deep subwavelength control of valley polarized cathodoluminescence in h-BN/WSe2/h-BN heterostructure. Nat. Commun. 2021, 12, 291.
7. H. Liu, X. Su, R. Fu, B. Wu, X. Chen, The flexible film of SCF/BN/PDMS composites with high thermal conductivity and electrical insulation. Compos. Commun. 2021, 23, 100573.
8. J. H. Kim, T. V. Pham, J. H. Hwang, C. S. Kim, M. J. Kim, Boron nitride nanotubes: synthesis and applications. Nano Convergence 2018, 5, 17.
9. E. A. Turhan, A. E. Pazargeviren, Z. Evis, A. Tezcaner, Properties and applications of boron nitride nanotubes. Nanotechnology 2022, 33, 242001.
10. P. Chithaiah, S. Ghosh, A. Idelevich, L. Rovinsky, T. Livneh, Alla Zak, Solving the “MoS₂ nanotubes” synthetic enigma and elucidating the route for their catalyst-free and scalable production, ACS Nano 2020, 14 3004-3016.
11. Y. Sun, S. Xu, Z. Xu, J. Tian, M. Bai, Z. Qi, Y. Niu, H. H. Aung, X. Xiong, J. Han, C. Lu, J. Yin, S. Wang, Q. Chen, R. Tenne, A. Zak, Y. Guo, Mesoscopic sliding ferroelectricity enabled photovoltaic random-access memory for the material-level artificial vision system. Nat Commun 2022, 13, 5391.
12. S. Ghosh, G. Otorgustb, A. Idelevich, O. Regev, I. Lapsker, D. Y. Lewitus, A. Zak, Reinforcement of poly (methyl methacrylate) by WS₂ nanotubes towards antiballistic applications, Compos Sci Technol. 2021, 207(3) 108736.
13. E. Magee, F. Tang, E. Ozdemir, M. Walker, T. DiLuccio, J. A. Kornfield, A. Zak, R. Tenne, T. McNally, WS₂ nanotubes as a 1D functional filler for melt mixing with poly (lactic acid): implications for composites manufacture, ACS Appl. Nano Mater. 2022, 5, 6385-6397.
14. A. Zak, L. Sallacan-ecker, A. Margolin, M. Genut, and R. Tenne, Insight into the growth mechanism of WS₂ nanotubes in the scaled-up fluidized-bed reactor, Nano 2009, 4, 91.
15. Y. J. Zhang, T. Ideue, M. Onga. et al. Enhanced intrinsic photovoltaic effect in tungsten disulfide nanotubes. Nature 2019, 570, 349-353.
16. F. Qin1, W. Shi, T. Ideue, M. Yoshida, A. Zak, R. Tenne, T. Kikitsu, D. Inoue, D. Hashizume, Y. Iwasa, Superconductivity in a chiral nanotube, Nat. Commun. 2017, 8, 14465.
17. M. B. Sreedhara, Y. Miroshnikov, K. Zheng, L. Houben, S. Hettler, R. Arenal, I. Pinkas, S. S. Sinha, I. E. Castelli, R. Tenne, Nanotubes from ternary WS₂₍₁₋ₓ₎Se₂ₓ alloys: stoichiometry modulated tunable optical properties. J. Am. Chem. Soc. 2022, 144, 10530-10542.
18. L. Rapoport, N. Fleischer, R. Tenne, Applications of WS₂ (MoS₂) inorganic nanotubes and fullerene-like nanoparticles for solid lubrication and for structural nanocomposites. J. Mater. Chem. 2005, 15, 1782-1788.
19. J. Xu, B. Yu, H. Zhao, S. Cao, L. Song, K. Xing, R. Zhou, X. Lu, Oxygen-doped VS₄ microspheres with abundant sulfur vacancies as a superior electrocatalyst for the hydrogen evolution reaction. ACS Sustainable Chem. Eng. 2020, 8 (39), 15055-15064.
20. T. V. Shubina, M. Remskar, V. Y. Davydov, K. G. Belyaev, A. A. Toropov, B. Gil, Excitonic emission in van der Waals nanotubes of transition metal dichalcogenides. Ann. Phys. (Berlin, Ger.) 2019, 531 (1-14), 1800415.
21. C. V. Ramana, V. V. Atuchin, I. B. Troitskaia, S. A. Gromilov, V. G. Kostrovsky, G. B. Saupe, Low-temperature synthesis of morphology-controlled metastable hexagonal molybdenum trioxide (MoO₃), Solid State Communications 2009, 149, 6-9.
22. X. Zhao, Z. Liu, W. Xiao, H. Huang, L. Zhang, Y. Cheng, J. Zhang, Low crystalline MoS₂ nanotubes from MoS₂ nanomasks for lithium-ion battery applications, ACS Appl. Nano Mater. 2020, 3 7580-7586.
23. S. Fathipour, M. Remskar, A. Varlec, A. Ajoy, R. Yan, S. Vishwanath, S. Rouvimov, W. S. Hwang, H. G. Xing, D. Jena, A. Seabaugh, Synthesized multiwall MoS₂ nanotube and nanoribbon field-effect transistor. Appl. Phys. Lett. 2015, 106, 022114(1-4).
24. J. V. B. Moura, J. V. Silveira, J. G. da Silva Filho, A. G. Souza Filho, C. Luz-Lima, P. T. C. Freire, Temperature-induced phase transition in h-MoO₃: stability loss mechanism uncovered by Raman spectroscopy and DFT calculations, Vibrational Spectroscopy 2018, 98, 98-104.
25. J. V. Silveira, J. V. B. Moura, C. Luz-Lima, P. T. C. Freire, A. G. Souza Filho, Laser-induced thermal effects in hexagonal MoO₃ nanorods, Vibrational Spectroscopy 2018, 98, 145-151.
26. P. Thangasamy, V. Shanmugapriya, M. Sathish, One-dimensional growth of hexagonal rods of metastable h-MoO₃ using one-pot, rapid and environmentally benign supercritical fluid processing. Phys. E: Low-Dimens. Syst. Nanostruct. 2018, 99, 189-193.
27. A. Chithambararaj, A. C. Bose, Role of synthesis variables on controlled nucleation and growth of hexagonal molybdenum oxide nanocrystals: Investigation on thermal and optical properties, CrystEngComm. 2014, 16, 6175-6186.
28. Tiwari, A. P.; Yoon, Y.; Novak, T. G.; Azam, A.; Lee, M.; Lee, S. S.; Lee, G.-h.; Srolovitz, D. J.; An, K.-S.; Jeon, S., Lattice Strain Formation through Spin-Coupled Shells of MoS2 on Mo2C for Bifunctional Oxygen Reduction and Oxygen Evolution Reaction Electrocatalysts. Chem. Eng. J. 2019, 0 (0), 1900948.
29. Kadam, S. R.; Kawade, U. V.; Bar-Ziv, R.; Gosavi, S. W.; Bar-Sadan, M.; Kale, B. B., Porous MoS2 Framework and Its Functionality for Electrochemical Hydrogen Evolution Reaction and Lithium Ion Batteries. ACS Appl. Energy Mater. 2019, 2 (8), 5900-5908.
30. Tsai, C.; Chan, K.; Abild-Pedersen, F.; Nørskov, J. K., Active edge sites in MoSe2 and WSe2 catalysts for the hydrogen evolution reaction: a density functional study. Phys. Chem. Chem. Phys. 2014, 16 (26), 13156-13164.
31. Zimron, O.; Zilberman, T.; Kadam, S. R.; Ghosh, S.; Kolatker, S.-L.; Neyman, A.; Bar-Ziv, R.; Bar-Sadan, M., Co-Doped MoSe2 Nanoflowers as Efficient Catalysts for Electrochemical Hydrogen Evolution Reaction (HER) in Acidic and Alkaline Media. Isr. J. Chem. 2020, 60 (5-6), 624-629.
32. Zhu, Q.; Chen, W.; Cheng, H.; Lu, Z.; Pan, H., WS2 Nanosheets with Highly-Enhanced Electrochemical Activity by Facile Control of Sulfur Vacancies. ChemCatChem 2019, 11 (11), 2667-2675.
33. Tang, L.; Xu, R.; Tan, J.; Luo, Y.; Zou, J.; Zhang, Z.; Zhang, R.; Zhao, Y.; Lin, J.; Zou, X.; Liu, B.; Cheng, H.-M., Modulating Electronic Structure of Monolayer Transition Metal Dichalcogenides by Substitutional Nb-Doping. Adv. Funct. Mater. 2021, 31 (5), 2006941.
34. Kadam, S. R.; Enyashin, A. N.; Houben, L.; Bar-Ziv, R.; Bar-Sadan, M., Ni-WSe2 nanostructures as efficient catalysts for electrochemical hydrogen evolution reaction (HER) in acidic and alkaline media. J. Mater. Chem. A 2020, 8 (3), 1403-1416.
35. Xu, J.; Yu, B.; Zhao, H.; Cao, S.; Song, L.; Xing, K.; Zhou, R.; Lu, X., Oxygen-Doped VS4 Microspheres with Abundant Sulfur Vacancies as a Superior Electrocatalyst for the Hydrogen Evolution Reaction. ACS Sustainable Chem. Eng. 2020, 8 (39), 15055-15064.
36. Kuraganti, V.; Siva, P.; Bar-Ziv, R.; Bar Sadan, M., Incorporating Nb into MoSe2 Nanoflowers for Overall Electrocatalytic Water Splitting. Isr. J. Chem. 2022, 62 (3-4), e202100055.
37. Addou, R.; Colombo, L.; Wallace, R. M., Surface Defects on Natural MoS2. ACS Appl. Mater. Interfaces 2015, 7 (22), 11921-11929.
38. Kumar, P.; Biswas, J.; Pandey, J.; Thakar, K.; Soni, A.; Lodha, S.; Balakrishnan, V., Selective Oxidation of WS2 Defect Domain with Sub-Monolayer Thickness Leads to Multifold Enhancement in Photoluminescence. Adv. Mater. Interfaces 2019, 6 (20), 1900962.

Acknowledgement of the above references herein is not to be inferred as meaning that these are in any way relevant to the patentability of the presently disclosed subject matter.

### BACKGROUND

The discovery of carbon fullerenes (C₆₀) and carbon nanotubes (CNTs) led to a new scientific domain of zero-dimensional (OD), one-dimensional (1D), and two-dimensional (2D) nanomaterials owing to their exclusive chemical and physical properties compared to their bulk counterparts. The particular interest of the scientific community was attracted by layered compounds, such as graphite, molybdenum disulphide (MoS₂), tungsten disulphide (WS₂), boron nitride (BN), etc. Thus, the discovery of graphene first time demonstrated the quantum Hall effect and massless Dirac fermions, suggesting a basis for faster and more powerful electronics [1]. 2D monolayers of MoS₂ [2] and WS₂ [3] reveal strong cathodoluminescence, control over chirality in the CNTs makes them metallic and semiconducting [4], h-boron nitride (BN) nanosheets show mechanical and thermal properties similar to graphene [5], cathodoluminescence [6], and electrical insulation and high thermal conductivity [7] were revealed in heterostructures with BN. Further exploration of 2D materials led to the wrapping and seaming of layered structures into chiral cylindrical tubes, resulting in the constitution of one-dimensional nanotubes [8-10].

Reducing the dimensionality of well-known materials from 3D (three-dimensional) bulk to 2D and, further, to 1D structures bring about polar nature and broken symmetry, bestowing them their properties, like ferroelectricity, piezoelectricity and photovoltaic effect, not existing in their 3D predecessor. This results in diverse applications in the fields such as electro-mechanics, optoelectronics, and memory devices [11]. In addition, WS₂ and MoS₂ 1D inorganic nanotubes have been proven as consequential materials for strengthening polymers [112] due to their inherent strength and good thermal stability [13], proper dispersion and adhesion to polymer. The synthesis of these materials in pure phase and scalable amounts is not a trivial task, while investigation of their properties and materials strongly depends on their availability. Currently, WS₂ INTs are in the superior stage compared to MoS₂ INTs; the WS₂ INTs have been synthesized on a large scale [14] and widely investigated for various applications such as bulk photovoltaic effect (BPVE) [15], superconductivity [16], optical properties [17], solid lubricants [18], etc. In addition, 2D layered transition metal dichalcogenides (TMDs) have been recognized as significant materials for electrocatalytic hydrogen evolution reaction (HER) due to their unique electronic configuration, layered structure, and electrochemical stability. However, their usage in electrocatalytic activity is limited due to their inactive basal planes [19], resulting in low conductivity and reduced activity. The required significant features to enhance the electrocatalytic hydrogen evolution reaction (HER) are lattice strain, higher basal surface defects, edge sites, and high surface area enriched in the currently prepared MoS₂ nanotubes.

### General Description

There is a need in the art for a novel technique for production of crystalline molybdenum disulfide (MoS₂) inorganic nanotubes (INTs).

MoS₂ inorganic nanotubes (INTs) are 40% lighter and are assumed to be 40% mechanically stronger than WS₂ INTs, and the emission of MoS₂ semiconductors INTs showed better results than WS₂ INTs [20]. Hence, 1D MoS₂ INTs are suitable to be used in significant optoelectronic applications.

In the early 1990s, the first MoS₂ INTs were synthesized from MoO₃ bulk powder using H₂/H₂S at an elevated temperature (850° C.) via gas-phase reactions. The obtained MoS₂ INTs yield was little and poorly reproducible. Following this discovery, several attempts have been made to prepare MoS₂ INTs. However, all the strategies were unsuccessful in producing pure-phase, good-yield, and highly crystalline MoS₂ INTs. Remarkably, WS₂ INTs were successfully synthesized on a large scale by the vapor-gas-solid (VGS) method only in 2009 [14].

Notwithstanding the similarity between the two compounds, until a recent study, the preparation and growth mechanism of MoS₂ INTs were ambiguous, reducing the reliability of large-scale production. In a recent investigation [10], a difference between the growth mechanisms of WS₂ and MoS₂ INTs was elucidated.

In brief, the synthesis of WS₂ INTs is a one-pot reaction process, where the reduction of precursor WO₃ powder into volatile WO_{2.75} suboxide and non-volatile WO₂ dioxide is followed by “chemical condensation” of these two oxide phases into stable W₁₈O₄₉ suboxide whiskers and their consequent sulfurization to WS₂ INTs. All steps of this reaction are accomplished at constant temperature and flow of reactive gases (H₂/H₂S). Unfortunately, the synthesis process of WS₂ INTs was unable to replicate the preparation of MoS₂ INTs as the interim Mo₄O₁₁ suboxide (similar to W₁₈O₄₉) is prone to over-reduction.

Thus, a new reaction strategy (two-step reaction) was developed [10] for the production of MoS₂ INTs in which (i) initial reduction of bulk MoO₃ (micron-size) powder to interim Mo₄O₁₁ suboxide nanowhiskers under H₂ gas flow was followed by subsequent (ii) sulfurization of the Mo₄O₁₁ nanowhiskers to MoS₂ nanotubes by using H₂S gas flow. Each step involved different parameters, including temperature and gas flows. Although this experimental strategy exhibited highly crystalline MoS₂ nanotubes, precise control of the chemical condensation process for the production of interim Mo₄O₁₁ nanowhiskers could not be achieved, resulting in a maximum of 40% yield of MoS₂ INTs [10].

The inventors of the present disclosure have found that in order to obtain exemplary MoS₂ nanotubes, an intermediate precursor of MoO₃ 1D nanowhiskers can be used which also serves as a templating agent for 1D MoS₂ nanotube preparation. However, the preparation of the high aspect ratio MoO₃ nanowhiskers in a pure phase and their following sulfurization into MoS₂ nanotubes reproducibly are challenging tasks due to the specific properties of MoO₃. First, most probably, only specific hexagonal molybdenum oxide (h-MoO₃) phase is ready to grow as a needle-like crystal and, second, MoO₃ is used to sublime starting from 400° C. Once sublimed, the 1D morphology of MoO₃ and its templating function is lost.

A few reports can be found in the literature attempting to prepare hollow MoS₂ nanotubes. Based on a similar perception, nano-masks of co-shelled MoOₓ/MoS₂ were prepared from MoO₃ rods and chemically etched with conc. HCl (concentrated hydrochloric acid) to remove the inner oxide [22]. However, continuous chemical etching reduces the crystallinity of the nanotubes, which deteriorates the formation of pure-phase highly crystalline MoS₂ nanotubes. Another study reports on chemical transport reaction elaborated for the preparation of multiwall MoS₂ hollow nanotubes [23], however, the reaction product represented a mixture of three MoS₂ phases: nanotubes, nanoribbons, and flakes.

In the present disclosure the inventors have developed a unique, and systematic two-step sulfurization process for the preparation of MoS₂ nanotubes from MoO₃ whiskers without compromising the 1D morphology. Further sulfurization according to the method of the present disclosure generates MoS₂ INTs with distinct tubular morphology.

In principle, sulfurization is a diffusion process starting from the surface of the molybdenum oxide nanowhiskers and continuing inward using external sulfide layers as a template and the deeper oxide core as a “building material” for the INTs growth, resulting in the formation of a hollow core in the rim of molybdenum sulfide layers. The formation of a hollow core in the INTs is attributed to the significant difference in the densities between MoS₂ and MoO₃ precursors.

To produce the oxide nanowhiskers, the inventors take as a basis a recently reported synthesis of hexagonal molybdenum oxide (h-MoO₃) nanorods with different aspect ratios (length/diameter). These nanorods were prepared via chemical precipitation method by acidification of an ammonium molybdate precursor with concentrated nitric acid (HNO₃) at a temperature range of 90-110° C. [24, 25]. However, these studies reported MoO₃ nanorods of limited aspect ratio with considerably large diameters and low length (D=50 nm-2 μm, L=1-30 μm and their aspect ratio is 10-60), unsuitable for producing large aspect ratio MoS₂ nanotubes. The primary limitation of such large-diameter tubes is the absence of hollow cores even after considerable sulfurization.

In order to prepare high-aspect ratio MoO₃ nanowhiskers (20-150 nm in diameter and up to 25 microns in length, with a maximum aspect ratio of 1250), the inventors of the present disclosure utilized the above-mentioned process, but significantly varied all the reaction parameters, such as a suitable set of reactants' concentrations, selection of suitable surfactant and its concentration, a unique way for heating, mixing and feeding the reactants into the reactor.

Generally, in facile synthesis processes, anionic surfactants have been proven to facilitate the growth of one-directional materials of different oxides, such as Fe₂O₃, ZnO, etc. Amongst anionic surfactants, sodium dodecyl sulfate (SDS) has been extensively used to prepare high aspect ratio 1D oxides by using an excess amount than micelle concentration and relying on their self-assembly crystallization. However, SDS has not been used as a structure-directing agent for synthesizing MoO₃ nanorods to their full potential. SDS has been used for MoO₃ microrod synthesis but resulted in a too large diameter, i.e., diameter ranging within 2-5 μm [26].

The inventors have found that SDS's diameter-restricting role towards other oxides is enticing for implementing them for MoO₃ through optimized reaction protocols. In the present disclosure, a systematic, modified synthetic procedure for the production of MoO₃ nanowhiskers is presented, comprising varying the reaction temperature, using an oil bath to maintain a uniform temperature, and adding nitric acid dropwise at a controlled rate using an automatic syringe pump.

Subsequent sulfurization of the h-MoO₃ nanowhiskers into MoS₂ nanotubes is an additional nontrivial task, and without the specific combination of parameters and reactor design, the tubular morphology of the nanotubes with a hollow core would be ambiguous.

The inventors have found that the sulfurizing process needs to be isolated in three exclusive steps. The first step renders the guiding initial sulfide layers on the surface of the h-MoO₃ nanowhiskers, which saves their 1D morphology by avoiding sublimation of MoO₃. This step is accompanied by the reduction of the inner core to MoO₂. The second and third high-temperature steps ensure the complete conversion of remaining molybdenum oxides to sulphide (MoS₂) accompanied by the formation of the hollow core and, finally, ensures straightening of the sulfide layers. The parameters influencing the morphology, the layer quality, and the hollow core are temperature, reaction time, and a combination and flow rates of hydrogen (H₂), hydrogen sulfide (H₂S), and nitrogen (N₂) gases. These parameters are to be harmonized in specific stoichiometric ratios to achieve high crystallinity tubular structure without compromising the 1D morphology.

The influence of each parameter was investigated by the inventors until the best combination could be reached for a scalable yield of MoS₂ nanotubes. The control over these parameters allows preparation of MoS₂ nanotubes in pure phase 1D morphology, high aspect ratio (D ˜20-150 nm, L ˜15 μm, aspect ratio 5-750, while some length reduction was ascribed to the handling of the sample during multiple reactions and sample preparation) and 100% yield. The obtained MoS₂ nanotubes can be of two crystallinity types; the first type (at times termed here as “type-I”) has tubes' walls including randomly oriented nanoplatelets, while the second type (so-called “type-II”) has layers substantially parallel to the tube axis (highly crystalline). The type-I nanotubes demonstrate superior performance in catalytic applications due to the vast density of the active sites on their surface, while the type-II nanotubes are the perfect material for optical and electronic applications.

In order to obtain the type-I MoS₂ nanotubes, the technique of the present disclosure utilizes the second sulfurization stage performed under predetermined relatively high temperature conditions. In order to obtain the type-II MoS₂ nanotubes, the technique of the present disclosure may further proceed towards the third stage of sulfurization under even higher temperature conditions and using the type-I MoS₂ nanotubes as a precursor.

It should be noted that the type-I MoS₂ INTs, having needle-like crystal with hollow core morphology and walls comprising the rolled MoS₂ layers with abundant surface defects or large amount of active sites in addition to curvature and strain, are advantageous for catalytic activity, as compared to MoS₂ bulk 2D structured material (platelets) comprising the plane layers with defect-free surface and relatively small amount of active sites at the layers' edges (as opposed to nanotube structure). This advantage of the type-I MoS₂ INTs with their larger number of active sites (or defects) as compared to bulk 2D platelets is due to the larger total surface area of the nanosized tubes, their stable closed caged tubular morphology and surface defects, obtained due to unique synthetic process developed here. Thus, the large surface area type-I MoS₂ INTs of the present disclosure, comprising abundant surface defects along the longitudinal axis of the MoS₂ INTs, results in high-density arrangement of active sites enabling enhanced catalytic activity as compared to bulk 2D MoS₂ platelets. Abundant active sites increase electron transport and electrical conductivity essential for effective catalytic reaction.

Thus, according to one broad aspect of the present disclosure, it provides a method of production of crystalline molybdenum disulfide (MoS₂) inorganic nanotubes (INTs), the method comprising:
performing initial synthesis of pure phase hexagonal molybdenum oxide (h-MoO₃) nanowhiskers, said h-MoO₃ nanowhiskers presenting a precursor and templating agent for producing the MoS₂ INTs;
performing a first-stage sulfurization of the precursor and templating agent, h-MoO₃, via a solid-gas reaction of the h-MoO₃ with reactive gases at first predetermined temperature conditions, said first stage sulfurization comprising partial reduction of h-MoO₃ nanowhiskers to MoOₓ-containing nanowhiskers (2≤x<3), followed by formation of nanostructures corresponding to an initial growth stage of MoS₂ INTs having cores comprising MoOₓ-containing nanowhiskers and initial MoS₂ intermittent guiding layers, configured as randomly oriented nanoplatelets or partially distorted layers, at the surface of the MoOₓ-containing nanowhiskers, such that said MoS₂ intermittent guiding layers provide protection against any one of sublimation or over-reduction of the MoOₓ at higher temperatures;
performing at least a second stage of sulfurization of said nanostructures via a solid-gas reaction thereof with reactive gases at second predetermined temperature conditions being relatively high as compared to the first temperature conditions, thereby providing recrystallization of said MoS₂ intermittent guiding layers to obtain highly crystalline layers and to complete sulfurization of MoOₓ inside the cores to MoS₂ and to obtain pure phase and high aspect ratio MoS₂ INTs of needle-like crystal with hollow core 1D morphology, and predetermined walls' structure.

The initial synthesis of the pure phase h-MoO₃ nanowhiskers can comprise a chemical precipitation process.

In some embodiments, the initial synthesis of MoO₃ whiskers is performed in an oil bath reactor (instead of using a beaker on a hot plate) to maintain a uniform temperature throughout a reaction time of the initial synthesis with a predetermined amount of double distilled water being heated, to thereby providing uniform temperature condition of the initial synthesis.

For example, the initial synthesis comprises the following:
(i) providing double distilled water in the oil bath reactor;
(ii) heating the double distilled water (e.g., for about 30-60 mins) to provide a reaction temperature of about 75-80° C. in said oil bath reactor;
(iii) adding ammonium molybdate tetrahydrate (NH₄)₆Mo₇O₂₄·4H₂O) and sodium dodecyl sulphate (CH₃(CH₂)₁₁OSO₃Na) and stirring (e.g., for 10 min) a mixture (e.g. 0.57-0.63 g ammonium molybdate tetrahydrate and 0.32-0.36 g of sodium dodecyl sulphate);
(iv) adding, to said mixture in a dropwise fashion, nitric acid HNO₃ (e.g., 18-22 mL of 69%-concentrated nitric acid HNO₃) at a predetermined drop rate (e.g., of 2.4 ml/min) to ensure uniform dropping, thereby obtaining a reaction solution; and
(v) stirring the reaction solution (e.g., for a further 15-30 min) to obtain a white milky precipitate, to thereby enable to obtain a clean precipitate of pure phase h-MoO₃ nanowhiskers.

For example, the majority of the pure phase h-MoO₃ nanowhiskers have an aspect ratio of up to 1250, e.g., have a diameter of 20-150 nm and a length of up to 25 microns.

In some embodiments, the majority and according to the discovered growth mechanism of the MoS₂ INTs, their aspect ratio after the second stage (and possibly also third stage) of sulfurization is obtained up to 750, e.g., have a diameter of about 20-150 nm and a length of up to 15 microns. The length and aspect ratio of the NTs is partially shortened during the multiple reaction steps and intermediate product handling.

In some embodiments, the first predetermined temperature is in a range of about 380-400° C. (temperature condition T₁).

In some embodiments, the partial reduction of h-MoO₃ to MoOₓ comprises interacting the h-MoO₃ with flows of the reducing agent H₂ and carrier gas N₂ at 5-20 ml/min and 100 ml/min flow rates, respectively, for about 10-20 min, to produce the MoOₓ-containing nanowhiskers being of MoOₓ/MoO₃ phase comprising a mixture of MoOₓ suboxide phases and MoO₃.

For example, the first stage sulfurization of h-MoO₃ further comprises interacting the MoOₓ/MoO₃ nanowhiskers with flows of reactive gases H₂S and H₂ and carrier gas N₂, at flow rates of 5-10 ml/min, 5-20 ml/min, and 100 ml/min, respectively, for a time period of 30-60 min. By this, the nanostructures are produced comprising the initial MoS₂ intermittent guiding layers on the surface of the MoOₓ/MoO₃ nanowhiskers such that the mixture of suboxide phases comprising Mo₄O₁₁, Mo₈O₂₃ and MoO₂ located inside the core of the MoS₂ INTs at the initial stage of their growth, and the MoS₂ intermittent guiding layers are located on the surface of the MoOₓ/MoO₃ nanowhiskers providing protection against any one of sublimation or over-reduction of MoOₓ core at higher temperatures.

In some embodiments, the method comprises applying the second and third stages of sulfurization to different portions of said nanostructures under differently controlled conditions.

In some embodiments, the second predetermined temperature maintained during the second stage sulfurization is 750-820° C. (temperature condition T₂). The MoS₂ nanotubes being produced have a needle-like crystal with hollow core morphology characterized by walls comprising the randomly oriented nanoplatelets along a longitudinal axis of the MoS₂ INTs, thereby forming a high-density arrangement of active sites enabling enhanced catalytic activity.

For example, the second stage sulfurization is carried out using flows of the reactive gas H₂S and a carrier gas N₂, at flow rates of 5-10 ml/min, and 80-100 ml/min, respectively, for a time period of 30-60 min.

For example, the MoS₂ INTs have enhanced catalytic activity in electrocatalytic hydrogen evolution reaction (HER).

In some embodiments, the third predetermined high temperature is 950° C. (temperature condition T₃). The MoS₂ INTs being produced have the needle-like crystal with hollow core morphology, and have walls' highly crystalline continual MoS₂ layers substantially parallel to a longitudinal axis of the INT.

For example, the third sulfurization stage is carried out using flows of H₂S, H₂ and N₂ gases, at flow rates of 5-10 ml/min, 5-10 ml/min and 80-100 ml/min, respectively, for a time period of 30-60 min, using type-I MoS₂ INTs as a precursor. The MoS₂ INTs with such walls' structure may be operable as optically or electrically active elements.

According to another broad aspect of the present disclosure, it provides a product configured as a precursor and a templating agent for producing therefrom highly crystalline molybdenum disulfide (MoS₂) inorganic nanotubes (INTs) via two-to-three successive stages of sulfurization, said product comprising pure phase hexagonal molybdenum oxide (h-MoO₃) nanowhiskers having an aspect ratio of up to 1250.

In yet further broad aspect of the present disclosure, it provides a product comprising molybdenum disulfide (MoS₂) inorganic nanotubes (INTs) having needle-like crystal with hollow core morphology and walls characterized by randomly oriented nanoplatelets along a longitudinal axis of the MoS₂ INTs, defining a high-density arrangement of active sites enabling enhanced catalytic activity.

The present disclosure, in its yet other aspect provides a product comprising molybdenum disulfide (MoS₂) inorganic nanotubes (INTs) having needle-like crystal with hollow core morphology and walls' structure characterized by highly crystalline continual MoS₂ layers substantially parallel to a longitudinal axis of the INT. These MoS₂ INTs may be operable as optically or electrically active elements. The highly crystalline structure of these nanotubes enables well-defined optical and electrical characteristics for optoelectronic applications, such as photovoltaic cells, piezoresistive sensors, infrared and visible range detectors, lithium and sodium batteries, memory devices, such as PV-RAM (photovoltaic random access memory), etc.

In yet another aspect, the present disclosure provides a product configured as a templating agent (precursor) for producing therefrom highly crystalline molybdenum disulfide (MoS₂) inorganic nanotubes (INTs) via two or three successive stages of sulfurization, said product being produced by the above-described synthetic method and comprising pure phase hexagonal molybdenum oxide (h-MoO₃) nanowhiskers having an aspect ratio of up to 1250.

As described above, the MoS₂ nanotubes having needle-like crystal with hollow core morphology and walls comprising the randomly oriented nanoplatelets along the longitudinal axis of the MoS₂ INTs, are characterized by the high-density arrangement of active sites enabling enhanced catalytic activity. Such MoS₂ nanotubes can be used to form an active surface of an electrode. To this end, the electrode (of any known suitable material- and geometrical characteristics) can be coated (using any known suitable technique) by the MoS₂ nanotubes. The electrode can then be placed to enable interaction between the active surface thereof and any selected analyte-containing medium to enable the required reaction to proceed. Such electrodes can be part of an electrolyzer or a fuel cell.

### BRIEF DESCRIPTION OF THE DRAWINGS

The patent or application file contains at least one drawing executed in color. Copies of this patent or patent application publication with color drawings will be provided by the Office upon request and payment of the necessary fee.

In order to better understand the subject matter that is disclosed herein and to exemplify how it may be carried out in practice, embodiments will now be described by way of non-limiting example only, with reference to the accompanying drawings, in which:

FIG. 1A is a schematic illustration of a reaction setup for performing the method of the present disclosure for the production of crystalline molybdenum disulfide (MoS₂) inorganic nanotubes (INTs).

FIG. 1B is a flow diagram of the main steps/stages in the method of the present disclosure for producing crystalline molybdenum disulfide (MoS₂) inorganic nanotubes (INTs).

FIGS. 2A to 2B are flow diagrams showing the method for production of crystalline molybdenum disulfide (MoS₂) inorganic nanotubes (INTs) according to the present disclosure, wherein FIG. 2A shows the method of the initial synthesis of pure phase hexagonal molybdenum oxide (h-MoO₃) nanowhiskers, and FIG. 2B shows the method of the first, second and third sulfurization steps/stages for preparing two types of pure phase and high aspect ratio MoS₂ INTs of predetermined morphology and dimensions;

FIGS. 2C and 2D illustrate, respectively, the exemplary process of the preparation of h-MoO₃ nanowhiskers, the production of crystalline MoS₂ INTs, and the structures of the resulting type-I and type-II MoS₂ INTs according to the technique of the present disclosure;

FIGS. 3A to 3B show SEM images of the top view (FIG. 3A) and lateral view (FIG. 3B) of h-MoO₃ nanorods, where the inset image in FIG. 3B depicts the “sea-urchin” shaped h-MoO₃ rods on the Si-substrate, from Ref. [21];

FIGS. 4A to 4B show SEM images of low magnification (FIG. 4A) and high magnification (FIG. 4B) of h-MoO₃ nanowhiskers with a high size distribution from 20 to up to 400 nm in diameter, from Ref. [10];

FIG. 5 is a schematic illustration of crystal structures of tunnel-shaped h-MoO₃ and α-MoO₃, from Ref. [27], responsible for the needle-like morphology of MoO₃ nanocrystals;

FIGS. 6A to 6D show SEM images of h-MoO₃ nanowhiskers prepared according to the method of the present disclosure, at low-to-high magnification, with low size distribution from 20 to up to 150 nm in diameter;

FIG. 6E shows XRD spectra the h-MoO₃ nanowhiskers obtained with the technique of the present disclosure, and, for comparison, also shows also the XRD pattern of MoO₃ standard;

FIGS. 7A to 7C show TEM images of MoS₂ INTs prepared at 380-400° C. (FIG. 7A), 750-820° C. (FIG. 7B), and 950° C. (FIG. 7C);

FIGS. 8A to 8C show XRD spectra of MoS₂ INTs prepared at 380-400° C. (FIG. 8A), 750-820° C. (FIG. 8B), and 950° C. (FIG. 8C);

FIGS. 9A to 9D are SEM images showing the hollow core morphology of the MoS₂ INTs obtained by the technique of the present disclosure;

FIGS. 10A to 10C show SEM images of nanobelts, nanoparticles, and nanorods, respectively (These morphologies are obtained when the specific reaction parameters of the present disclosure are not strictly followed);

FIGS. 11A to 11D show results of linear sweep voltammetry (LSV) measurements performed with different structures of VS₂, WS₂ and MoS₂ (VS₂ tubes, WS₂ tubes, MoS₂ tubes, VS₂ flowers WS₂ triangles and MoS₂ flowers) in acidic (FIGS. 11A and 11B) and alkaline (FIGS. 11C and 11D) media, wherein FIG. 11A shows HER polarization curves in 0.5 M H₂SO₄; FIG. 11B shows corresponding Tafel plots obtained from the polarization curves of FIG. 11A; FIG. 11C shows HER polarization curves in 0.5 M KOH; and FIG. 11D shows corresponding Tafel plots obtained from the polarization curves of FIG. 11C; and

FIG. 12 shows a chemically activated electrode configured according to the present disclosure.

### DETAILED DESCRIPTION OF EMBODIMENTS

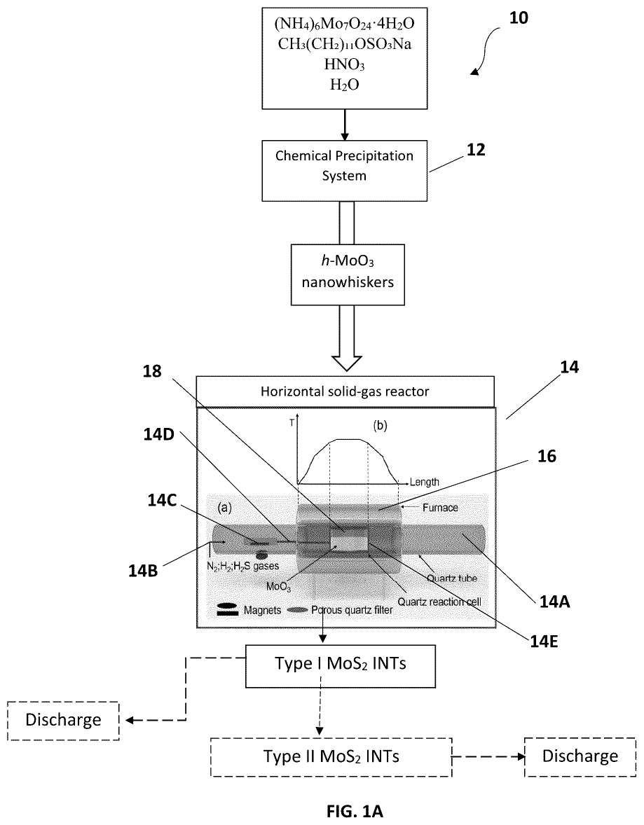

Referring to FIG. 1A, there is schematically illustrated a system 10 configured and operable to implement the technique of the present disclosure for producing crystalline molybdenum disulfide (MoS₂) inorganic nanotubes (INTs). The system 10 includes a list of reactants, a chemical precipitation unit 12 (oil bath reactor), and a reaction setup 14 configured as a horizontal tubular quartz reactor having a region thereof passing through a high temperature furnace 16.

The chemical precipitation unit 12 is configured and operable to perform the initial synthesis of pure phase hexagonal molybdenum oxide (h-MoO₃) nanowhiskers, which serves as a precursor and templating agent for further production of the MoS₂ INTs.

The reaction setup 14 has a tubular furnace 16, tubular reactor (quartz tube) 14A, which has a gas input 14B for entering the carrier/reactive gases such as N₂, H₂, H₂S, and quartz reaction cell 14E made of porous quartz filter. The cell is connected to quartz handle 14D with a small magnet 14C embedded into the handle's end to introduce the cell into the reactor, and a reaction zone 18 for as-prepared precursor MoO₃ nanowhiskers to be loaded towards the sulfurization reaction. As will be described further below, the reactor is configured and operable to perform the sequential first, second and third stages of sulfurization to obtain pure 1D crystalline phase and high aspect ratio MoS₂ INTs of predetermined morphology and dimensions. As also shown in FIG. 1A, there is the temperature profile of the furnace which confirms the constant temperature along the region of reaction zone 18 passing through the furnace.

FIG. 1B shows a flow diagram 100 of the main steps/stages in the technique of the present disclosure to produce crystalline MoS₂ INTs. In step 102, the initial stage is performed including the initial synthesis of pure-phase hexagonal molybdenum oxide (h-MoO₃) nanowhiskers. These h-MoO₃ nanowhiskers present a precursor and templating agent for further production of the MoS₂ INTs.

Then, a first stage sulfurization of the precursor and templating agent, h-MoO₃, is performed (step 104). This utilizes a solid-gas reaction of the h-MoO₃ with reactive gases (H₂, H₂S) at the first predetermined temperature conditions Ti. This first stage of sulfurization includes partial reduction of h-MoO₃ nanowhiskers to MoOₓ-containing nanowhiskers (2≤x<3), which is followed by the formation of nanostructures corresponding to an initial growth stage of MoS₂ INTs. These nanostructures have cores comprising MoOₓ-containing nanowhiskers and initial MoS₂ intermittent guiding layers at the surface of the MoOₓ-containing nanowhiskers. These initial MoS₂ intermittent guiding layers are configured as randomly oriented nanoplatelets or as partially distorted layers, and they provide protection against sublimation and/or over-reduction of the MoOₓ at higher temperatures.

The so-obtained nanostructures presenting the initial growth stage of MoS₂ INTs proceed to second and third stages of sulfurization (step 106) performed via a solid-gas reaction at second and third predetermined temperature conditions T₂, T₃ such that T₂ and T₃ are relatively high as compared to the first temperature conditions Ti. This provides recrystallization of the MoS₂ intermittent guiding layers to obtain highly crystalline substantially parallel layers, to sulfurize MoOₓ inside the cores to MoS₂, and obtain pure phase and high aspect ratio MoS₂ INTs of needle-like crystal with hollow core morphology and predetermined walls' structure and dimensions.

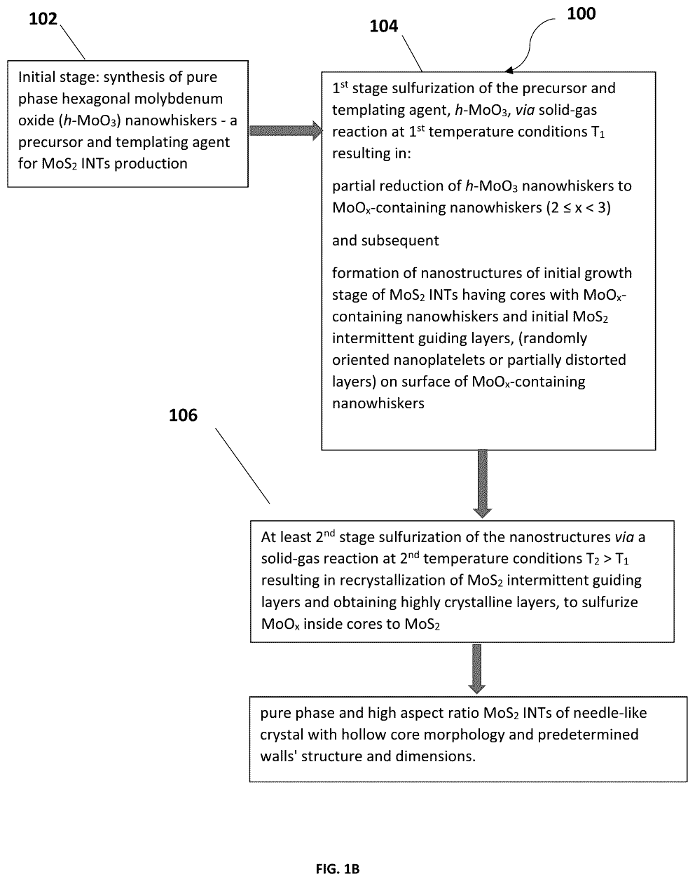

Reference is made to FIGS. 2A and 2B showing more specifically the exemplary implementations of the above-described steps/stages for the production of crystalline molybdenum disulfide (MoS₂) inorganic nanotubes (INTs) according to the present disclosure.

FIG. 2A shows a flow diagram 200 of the initial synthesis of pure phase hexagonal molybdenum oxide (h-MoO₃) nanowhiskers, where the h-MoO₃ nanowhiskers present a precursor and templating agent for producing MoS₂ INTs.

The inventors found the conditions for obtaining very thin and long h-MoO₃ nanowhiskers by controlling the uniform and unidirectional growth of the whiskers in contrast to the reported literature where rods were prepared with a low aspect ratio (10), wide diameter (500-700 nm), flower and ‘sea-urchin’ ‘agglomerates’ morphology. Specifically, the inventors found the optimal (or even only suitable) set of reactants concentrations and a unique way for heating, mixing and feeding the reactants into the reactor for the preparation of h-MoO₃ nanowhiskers to thereby obtain them with the controlled sizes, with a high aspect ratio (up to 1250) and narrow size distribution of diameter (20-150 nm), contrary to the previous report [15] where diameters varied between 40-400 nm.

The initial synthesis of oxide nanowhiskers is performed in an oil bath reactor (instead of using a beaker directly on hotplate) to maintain uniform temperature throughout the reaction time of the initial synthesis. In a typical synthetic procedure, before the reaction, 8-12 ml of double distilled water was taken in the round-bottom flask and heated in an oil bath at 75-80° C. for 30-60 min on a hot plate integrated with a magnetic stirrer (step 202) to optimize the water temperature throughout the reaction time. The inventors optimized the reaction temperatures to 75-80° C. instead of the reported 90-110° C. and others (including timing, concentrations of reactants and surfactant, feeding of reactants, and mixing protocol). The reported temperatures of 90-110° C. result in a smaller aspect ratio or not in a 1D morphology.

In a typical synthetic procedure, 0.46-0.51 mM (0.57-0.63 g) ammonium molybdate tetrahydrate (AMT) and 1.11-1.25 mM (0.32-0.36 g) SDS were added to the pre-heated double distilled water and stirred for 10-15 min to make a homogeneous solution mixture with constant stirring (step 204).

Following this, 18-22 ml concentrated nitric acid (69%) was added dropwise to the above solution mixture at a specific rate of 2.4 ml/min using an automated syringe pump controller to ensure uniform dropping (step 206). This controlled feeding rate of the nitric acid was shown by the inventors to be critical for obtaining the desired morphology of the h-MoO₃ nanowhiskers.

At the same time, the stirring was continued for a further 15-30 min (step 208) to obtain a white milky precipitate. After the desired precipitate was obtained, the flask was taken out of the oil bath and cooled down to room temperature naturally (step 210), washed with distilled water (three times) and ethanol (two times) (step 212) to remove the reaction residuals, centrifuged, and then dried in an open atmosphere at room temperature for further analysis (step 214).

The final experimental parameters for obtaining MoO₃ nanowhiskers were found as follows:
Ammonium molybdate tetrahydrate: (NH₄)₆Mo₇O₂₄·4H₂O—0.57-0.63 g,
Sodium dodecyl sulphate (SDS, surfactant): CH₃(CH₂)₁₁OSO₃Na—0.32-0.36 g,
Water—8-12 ml and HNO₃-18-22 ml (2.4 ml/min)
Reaction temperature: 75-80° C. and time: 15-30 mins.
   The chemical reaction for obtaining MoO₃ nanowhiskers follows in Eq. (1):

$${( {NH}_{4} )}_{6} {Mo}_{7} {O}_{24} \cdot 4 {H}_{2} O + {H}_{2} O + 6 {HNO}_{3} \frac{SDS}{75 - 80 °C} = 7 {MoO}_{3} + 6 {NH}_{4} {NO}_{3} + 8 {H}_{2} O \qquad ( 1 )$$

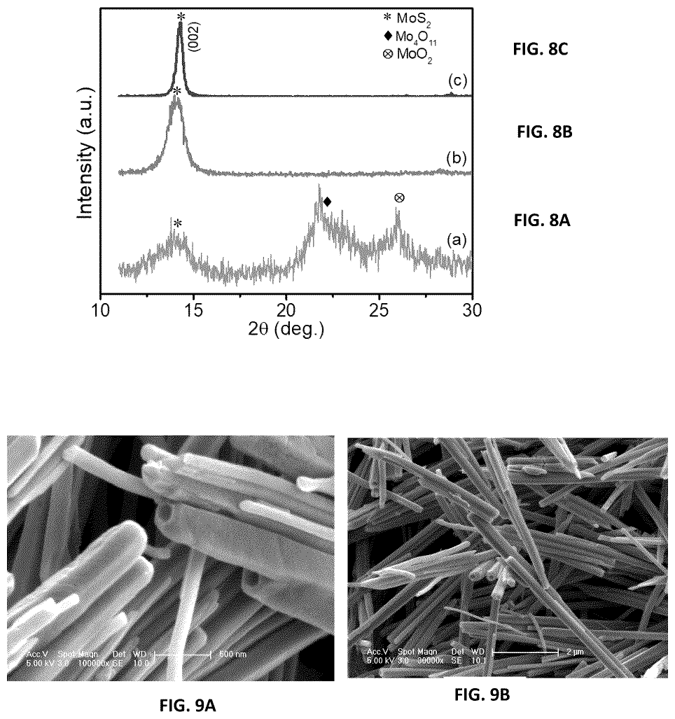

Increase in time or temperature results in a larger size distribution of MoO₃ whiskers (20-400 nm); a lower or higher concentration of SDS surfactant results in a short length (few microns) and large diameter (400-700 nm) rods; direct addition of nitric acid results in the formation of nanobelts (instead of nanowhiskers); change in concentrations of all reactants and rate of dropping results in different morphology such as nanoparticles or rods formation instead of uniform (low size distribution) and high aspect ratio nanowhiskers. FIGS. 10A to 10C show various morphologies obtained when the specific reaction parameters of the present disclosure are not strictly followed.

Further, the inventors clarified that pure hexagonal phase of MoO₃ with tunnelling structure along the whisker axis was essential to direct the growth of 1D needle-like whiskers (MoO₃ could be orthorhombic or hexagonal). The inventors tuned the reaction to obtain h-phase. It should be noted that higher temperature synthesis of MoO₃ whiskers results in orthorhombic phase and loss of 1D morphology.

The pre-prepared h-MoO₃ nanowhiskers by method 200 are used as a precursor and templating material for preparing MoS₂ INTs via a ‘solid-gas’ reaction, with two-step-temperature growth using H₂S, H₂ as reactive gases and N₂ as a carrier gas, as described by the method 300 shown in FIG. 2B.

Since the MoO₃ 1D nanowhiskers are essential for 1D MoS₂ nanotube preparation, being used as a templating agent, the dimensions of the resulting 1D MoS₂ INTs are close to the sizes of MoO₃ 1D nanowhiskers. However, sulfurization of the MoO₃ nanowhiskers into MoS₂ nanotubes is challenging due to the specific properties of MoO₃, which sublimes starting from 400° C. Once sublimed, the 1D morphology of MoO₃ and its templating function for nanotubes' growth is lost.

In the present disclosure, the inventors developed a unique two-to-three step sulfurization process for preparing MoS₂ nanotubes from MoO₃ whiskers without compromising the 1D morphology. Moreover, the inventors can control the synthesis to prepare two types of these nanotubes: First-type (type-I) MoS₂ nanotubes with walls comprising small, randomly oriented layers resulting in defect-rich nanotubes' surface, but without compromising morphology, this property enhancing the catalytic activity of MoS₂ NTs; and second-type (type-II) MoS₂ nanotubes with walls comprising highly crystalline parallel MoS₂ layers, suitable for applications in optoelectronics and electro-mechanics.

The method 300 starts (step 302) by preparing h-MoO₃ nanowhiskers by method 200, which, as mentioned above, are needed as a precursor and templating agent for 1D MoS₂ nanotube preparation.

Short reduction of MoO₃ to MoOₓ precedes the first sulfurization step (step 304). Reduction to MoOₓ is one of the process parameters used to avoid sublimation and conserves 1D morphology. The parameters for this short reduction reaction are T=380-400° C., gas flows: N₂=100 ml/min, H₂=5-20 ml/min, reaction time t=10-20 min.

Given the instability of h-MoO₃ at elevated temperatures, the first stage sulfurization reaction (306) is executed at a lower temperature (380-400° C.), with additional process parameters to avoid MoO₃ sublimation, using H₂S, H₂ as reactive gases and N₂ as a carrier gas, resulting in Mo₄O₁₁/MoO₂ core encapsulated inside the MoS₂ shells. The experimental parameters of this step are: T=380-400° C., gas flows: N₂=100 ml/min, H₂=5-20 ml/min, H₂S=5-10 ml/min, reaction time=30-60 min.

It should be noted that these parameters are extremely important, as over-reduction/sulfurization will destroy nanowhiskers and result in their collapse. The first sulfurization renders randomly oriented intermittent MoS₂ guiding layers at the periphery of the nanotubes and Mo₄O₁₁/MoO₂ inside the core (step 308). These guiding layers serve to protect against possible sublimation at higher temperatures.

It should be noted that, while the formation of the initial guiding MoS₂ layers is essential to avoid MoO₃ sublimation or collapse, the parameters of this reaction could vary in a wide range. However, all parameters, like temperature, timing, and H₂S/H₂ flows, are to be properly selected to provide very quick sulfurization of the full surface layer of the whiskers, such that this is performed quicker than the sublimation of MoO₃.

Thus, the inventors demonstrated that similar results could also be obtained if the first sulfurization reaction is carried at higher temperatures like 750-820° C. Obviously, at such temperatures, the kinetics of both sublimation as well as sulfurization of MoO₃ is much faster. Therefore, the H₂S gas flow should be increased in parallel with temperature. In such a way, the morphology of the nanotubes is maintained and the creation of the guiding layers is achieved.

For example, the parameters of such reactions are: T=750-920° C., gas flows: N₂=80-90 ml/min, H₂=10 ml/min, H₂S=10-50 ml/min, reaction time=5 sec-5 min.

It is noted that the protocol for the first stage sulfurization is common for production of both first-type (type-I) and second-type (type-II) MoS₂ INTs of the present disclosure.

The first stage sulfurization is followed by the high-temperature (T₂, e.g., 750-820° C.) second stage sulfurization, and possibly further followed by the higher-temperature (T₃, e.g., 950° C.) third stage sulfurization. Both, the second and third stages of sulfurization provide recrystallization of the MoS₂ intermittent guiding layers to obtain highly crystalline parallel layers and sulfurizing the residual MoOₓ accompanied by the creation of a needle-like crystal with hollow core morphology, and to obtain pure phase and high aspect ratio MoS₂ INTs of predetermined walls' structure and dimensions. The second stage sulfurization results in the type-I MoS₂ INTs (step 312) having tubes' walls including randomly oriented nanoplatelets, and the third stage sulfurization results in the type-II MoS₂ INTs having layers substantially parallel to the tube axis.

In order to obtain the type-I MoS₂ INTs, the second stage sulfurization (step 310) may include the following reaction parameters: T₂=750-820° C., N₂=80-100 ml/min, H₂S=5-10 ml/min, reaction time=30-60 min.

In order to obtain the type-II MoS₂ INTs, the third stage sulfurization (step 314) may be performed using the following reaction parameters: T₃=950° C., N₂=80-100 ml/min, H₂=5-10 ml/min, H₂S=5-10 ml/min, and reaction time=30-60 min using type-I MoS₂ INTs as a precursor. The type-II MoS₂ INTs are characterized by walls' structure comprising highly crystalline continual layers parallel to tube axis with a hollow core (316). The chosen reaction parameters cause recrystallization of the disordered layers and render continual parallel MoS₂ layers to the final nanotube.

The obtained MoS₂ nanotubes of both types are 20-150 nm in diameter and up to 15 microns in length, exhibiting a high aspect ratio of up to 750 (step 318). It is noted that nanotubes' diameter of ≥120 nm renders more distorted MoS₂ layers on the periphery, and partial shortening of the whiskers was ascribed to the handling of the sample during multiple reactions and sample preparation.

FIGS. 2C and 2D exemplify, in a self-explanatory manner, the above-described chemical processes (initial synthesis and first, second and third sulfurization stages) and the resulting MoS₂ INTs.

In the following, the method of the present disclosure is described in more detail with reference to analytical techniques used to characterize the various synthesis stages.

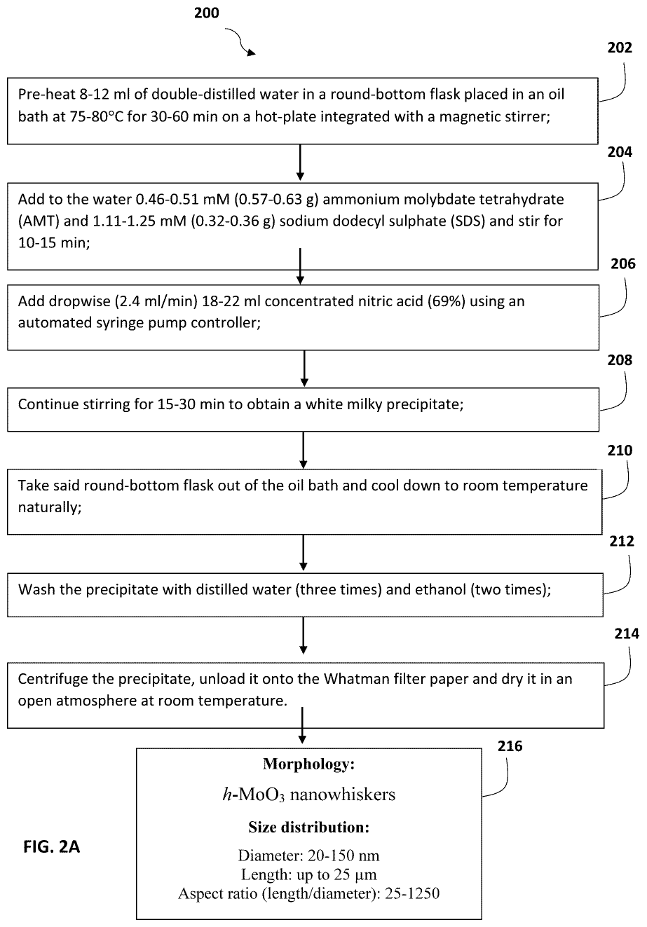

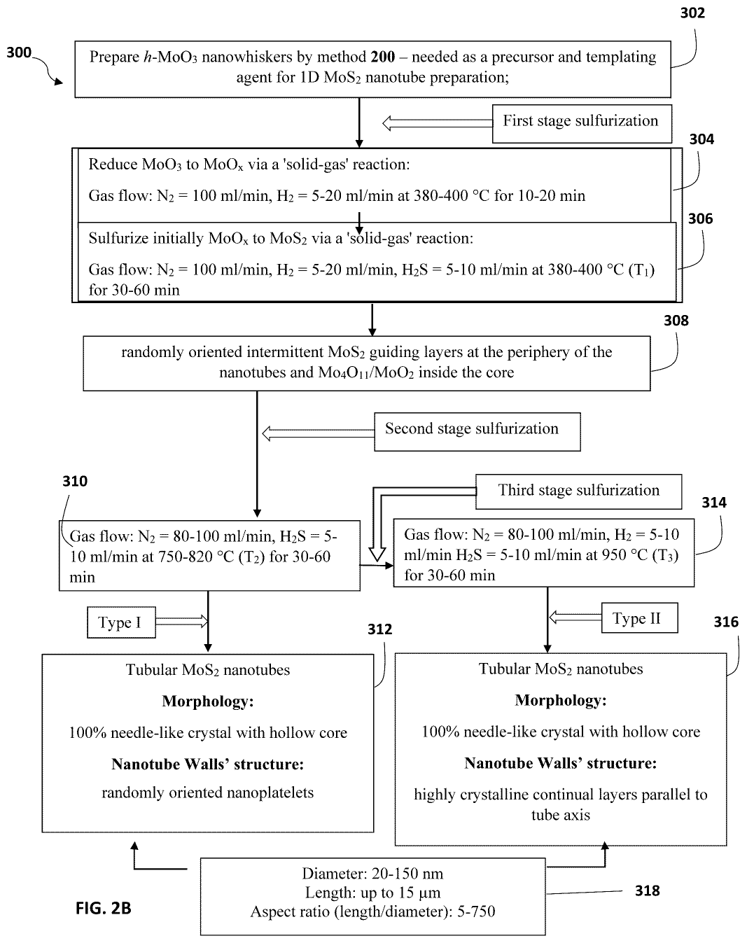

Reference is made to FIG. 3A to 3B showing the SEM images of h-MoO₃ nanorods prepared by Ramana et al. [21], which reaction approach has been used as a reference by the inventors to prepare high-aspect-ratio h-MoO₃ nanowhiskers by substantially modifying the parameters used in the present disclosure. A straight hexagonal rod-shaped morphology (FIGS. 3A and 3B) of 500-700 nm in diameter was reported, and their calculated aspect ratio was about 10-60. The first attempts of the inventors to modify this synthesis [10] resulted in a reduction of the whisker's diameter, with a majority of the whisker's diameters being 80-150 nm. However, the size distribution of the h-MoO₃ nanowhiskers obtained by that process was still wide, ranging from 40 nm to 400 nm; the agglomeration morphology appeared like a flower, a property which could impede the dispersion of the agglomerates into individual nanotubes; their lengths were up to a few microns only as shown in FIGS. 4A to 4B, and a few hexagonal-shaped rods could be seen as well. Using the novel technique of the present disclosure, the inventors succeeded in preparing a pure hexagonal h-MoO₃ phase (MoO₃ could be orthorhombic or hexagonal) with a structure along the whisker axis which is essential for the growth of 1D needle-like whiskers.

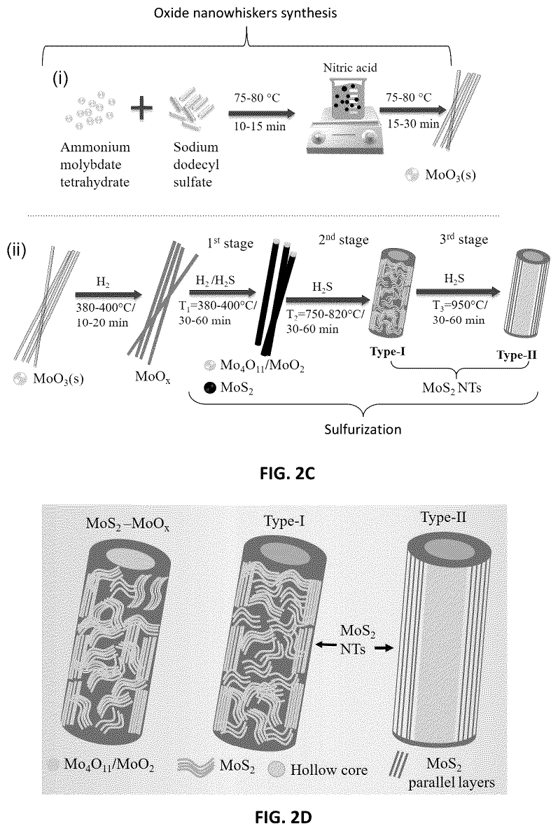

As mentioned above, the inventors tuned the reaction to obtain the h-phase MoO₃ since higher temperature synthesis of whiskers results in orthorhombic phase and loss of 1D morphology. The schematic representations of h-MoO₃ and α-MoO₃ crystal structures are shown in FIG. 5.

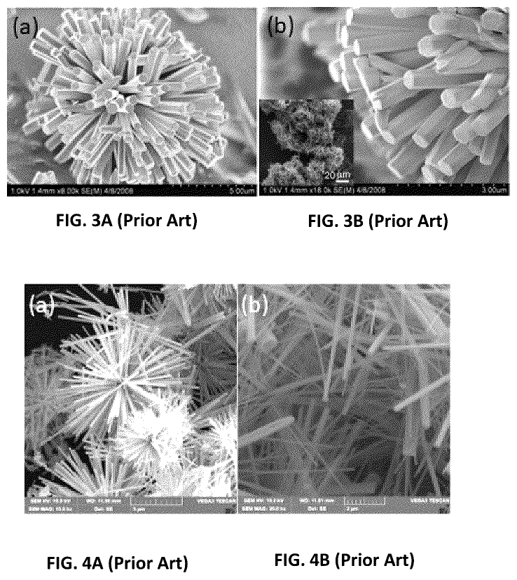

FIGS. 6A to 6D show low-high magnification SEM images of h-MoO₃ nanowhiskers with a high-aspect-ratio prepared by the method of the present disclosure and FIG. 6E shows XRD spectra the h-MoO₃ nanowhiskers obtained with the technique of the present disclosure. For comparison, FIG. 6E shows also the XRD pattern of MoO₃ standard. The obtained nanowhiskers are thin, long, isolated (not flower-like), and formed as typical nanowhiskers morphology. Moreover, owing to their longer lengths and needle-like morphology (not tangled spaghetti-like wires), they are piled up and create a network-like structure that can be easily dispersed by a simple sonication process. The diameter of the as-prepared whiskers is 20-150 nm, and their lengths are up to 25 μm. The overall aspect ratio of the obtained whiskers is 25-1250 (taking D ˜20-150 nm and L up to 25 μm), which is (at the maximum achievable aspect ratio) at least 20 times higher than the reported literature (literature aspect ratio is 10-60) and may reach even two orders of magnitude higher aspect ratios than reported in the literature. The modified synthesis strategy of the present disclosure nurtures the growth and nucleation of crystals uniformly in one direction and leads to the formation of desired h-MoO₃ nanowhiskers. In addition, the inventors found that an increase in time or temperature results in the large size distribution of whiskers (20-400 nm); a low or high concentration of SDS surfactant results in a short length (few microns) and large diameter (400-700 nm) rods; direct addition of nitric acid (instead of dropping) results in the formation of nanobelts (instead of nanowhiskers); change in concentrations of all reactants and rate of nitric acid dropping results in different morphology nanoparticles/rods formation instead of nanowhiskers.

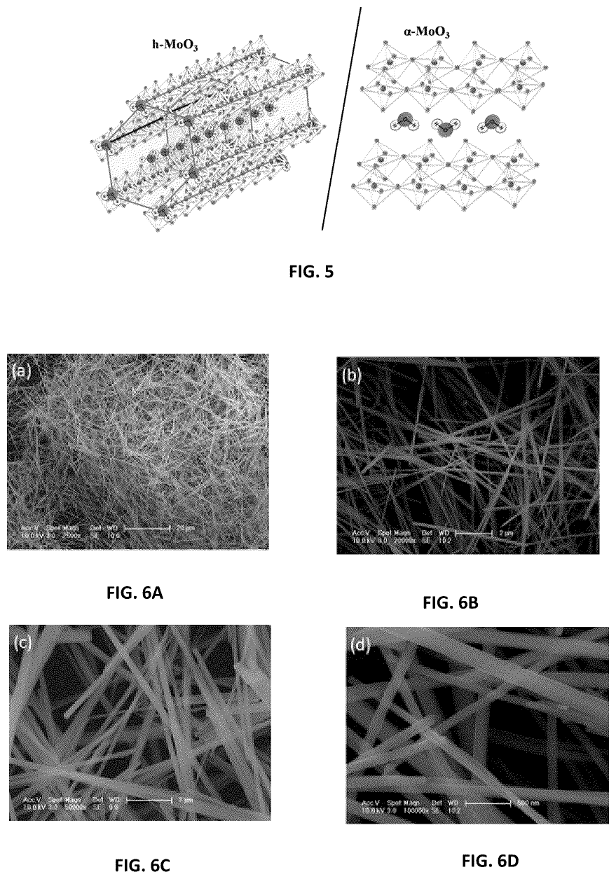

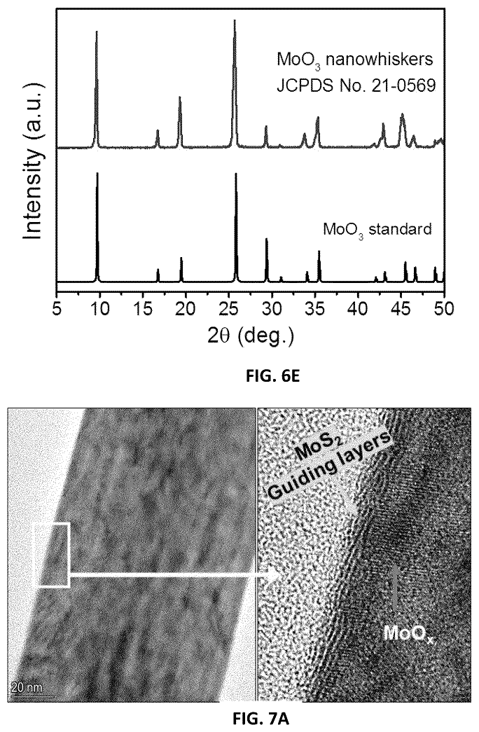

The MoS₂ INTs, according to the method of the present disclosure, can be prepared of two types in a controllable way. FIGS. 7A to 7C depict the TEM images of MoS₂ INTs obtained after the first, second and third sulfurization stages of MoO₃ nanowhiskers. As shown in FIG. 7A, the first sulfurization reaction of h-MoO₃ at 380-400° C. under H₂S/H₂ flow renders the morphological features, namely, (i) formation of the partially distorted MoS₂ guiding layers at the periphery of the nanotubes and (ii) quick reduction of MoO₃ into a mixture of suboxide phases of Mo₄O₁₁/MoO₂ inside the guiding layers. Before the sulfurization, a short reduction of MoO₃ to MoOₓ (380-400° C., N₂ gas=100 ml/min, H₂=5-20 ml/min, time=10-20 min) precedes the first sulfurization step. Reduction to MoOₓ is one of the parameters to avoid sublimation and conserve 1D morphology (XRD patterns of reduced Mo₄O₁₁/MoO₂ phases are shown in FIG. 8A).

The second and third sulfurization reactions at elevated temperatures (T₂ and T₃, respectively) form two types of MoS₂ INTs. As described above, the process may include only first and second stages resulting in type-I MoS₂ INTs, or may further proceed towards higher-temperature third stage of sulfurization resulting in type-II MoS₂ INTs.

The type-I MoS₂ INTs (second stage sulfurization under temperature conditions of T₂=750-820° C.) comprise walls' structure defining randomly oriented nanoplatelets along a longitudinal axis of the MoS₂ INT which may be also described as short intermittent MoS₂ guiding layers at the periphery of the nanotubes and Mo₄O₁₁/MoO₂ inside the core owing to defect-rich nanotubes' surface (FIG. 7B). The characteristic features such as distorted MoS₂ layers on the periphery (higher defects, edge sites), lattice strain (generated due to bending), and high surface area (formed due to a high-aspect-ratio and nanosize) of these nanotubes have been generated exclusively for their applications in electrocatalytic hydrogen evolution reaction (HER) which act as active sites and enhance the catalytic activity. Nanotubes' diameter of ≥120 nm renders more distorted MoS₂ layers on the periphery.

The type-II MoS₂ INTs (third stage sulfurization under temperature conditions of T₃=950° C.) results from the complete conversion of oxide to MoS₂ providing walls' structure characterized by highly crystalline, continual MoS₂ layers parallel to the tube axis (FIG. 7C). Concurrently, a hollow core is formed due to the density differences between the MoO₂ and MoS₂. In addition, some randomly oriented MoS₂ platelets are also observed in some tubes. These highly crystalline nanotubes are suitable for applications in optoelectronics and electro-mechanics.

X-ray diffraction (XRD) patterns of MoS₂ nanotubes at the different stages of their synthesis are shown in FIGS. 8A to 8C. FIG. 8A depicts the XRD of NTs prepared at 380-400° C. with abroad (002) peak, characteristic to distorted layers, at 14.3° corresponding to the characteristic feature of the hexagonal MoS₂ phase with a JCPDS No. 6-97 and space group P6₃/mmc (no. 194). In addition, peaks corresponding to residual Mo₄O₁₁ suboxide and MoO₂ after the first low-temperature sulfurization are clearly observed. The obtained Mo₄O₁₁ suboxide signifies the orthorhombic phase (JCPDS No. 5-337) and MoO₂ to the monoclinic phase (JCPDS No. 32-671). In contrast, FIGS. 8B and 8C show the diffraction patterns of MoS₂ INTs obtained after the second and third sulfurization stages at 750-820° C. and 950° C., respectively, producing 100% MoS₂ indicating comprehensive conversion of the core oxide into sulfide and, finally, the straightening of the layers, respectively. The thin (002) peak on FIG. 8C points on highly crystalline MoS₂ INTs obtained at 950° C.

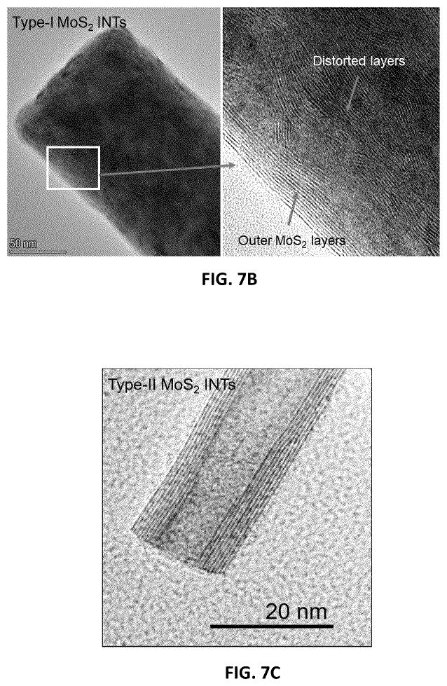

FIGS. 9A to 9D are SEM images showing the hollow core morphology of the MoS₂ INTs obtained by the technique of the present disclosure.

Thus, in the present disclosure, h-MoO₃ nanowhiskers with a high-aspect-ratio have been synthesized using a chemical precipitation method. The obtained h-MoO₃ nanowhiskers are crystalline and one-dimensional. The aspect ratios of h-MoO₃ nanowhiskers are 20-125 times higher than previously reported. The as-prepared h-MoO₃ nanowhiskers were used as a chemical precursor and template for the preparation of peerless MoS₂ inorganic nanotubes by a two-to-three step sulfurization process using H₂S/H₂ as reactive gases. After the first sulfurization reaction of h-MoO₃ whiskers, the intermittent MoS₂ guiding layers are formed on the nanowhiskers' rim, with reduced Mo₄O₁₁ and MoO₂ core. After the second sulfurization at 750-820° C., distorted MoS₂ layers on the periphery were generated exclusively for applications in catalysis, where they act as active catalytic sites and enhance the catalytic activity. After third stage of sulfurization at 950° C., pure-phase, highly crystalline MoS₂ INTs were obtained with continual layers parallel to the tube axis with a hollow core inside and some distorted MoS₂ layers.

The highly crystalline structure of the type-II nanotubes enables well-defined optical and electrical characteristics for opto-electronic applications, such as photovoltaic cells, piezoresistive sensors, infrared and visible range detectors, lithium and sodium batteries, memory devices, such as PV-RAM (photovoltaic random access memory), etc.

In the following, the inventors demonstrate that the first-type MoS₂ INTs of the present disclosure are advantageous in catalytic reactions, e.g., in hydrogen evolution reaction (HER), showing the best intrinsic activity when compared to other metal dichalcogenides, the activity being enhanced by an extensive electrochemical surface area of the first-type MoS₂ INTs.

Layered transition metal dichalcogenides (TMD) such as MoS₂ [28,29], MoSe₂ [30,31], WS₂ [32,33], and WSe₂ [34] are well-known electrocatalysts towards the hydrogen evolution reaction (HER) due to their layered structure, unique electronic configuration, and electrochemical stability. The highly active catalytic sites in these materials are located at the layers' edges, while the van der Walls basal planes are practically inactive—the main limitation for the further improvement of the electrocatalytic activity [35]. Similar characteristics for the nanoflowers morphology compared to the bulk structure were previously reported by Bar Sadan, which were attributed to the defective basal plane and abundant edges, inherent to the nanoflowers morphology [29,34]. In addition, the effect of strain was also reported, showing that strain can modulate the hydrogen binding properties [36-38]. However, the nanoflowers are produced in small batches with heavy organic solids, that are retained on the structures as ligands and residues, and hamper the catalytic activity. Moreover, these heavy organic mixtures are expensive and therefore this production protocol has less commercial potential. In contrast, solid gas production of MoS₂ structures provides clean surfaces. In addition, the formation of defect-rich interfaces between the solid catalyst and the liquid electrolyte is especially beneficial for the electro-catalytic activity, making these specific nanotubes of unique value.

To demonstrate the activity towards the hydrogen evolution reaction, the inventors performed linear sweep voltammetry (LSV) measurements in acidic (0.5M H₂SO₄) and alkaline (0.5M KOH) media for a group of related layered materials. It is noted that the WS₂ in this study have perfectly oriented molecular layers along the tubes' axis, demonstrating the significant advantage of the defected MoS₂ nanotubes as catalysts.

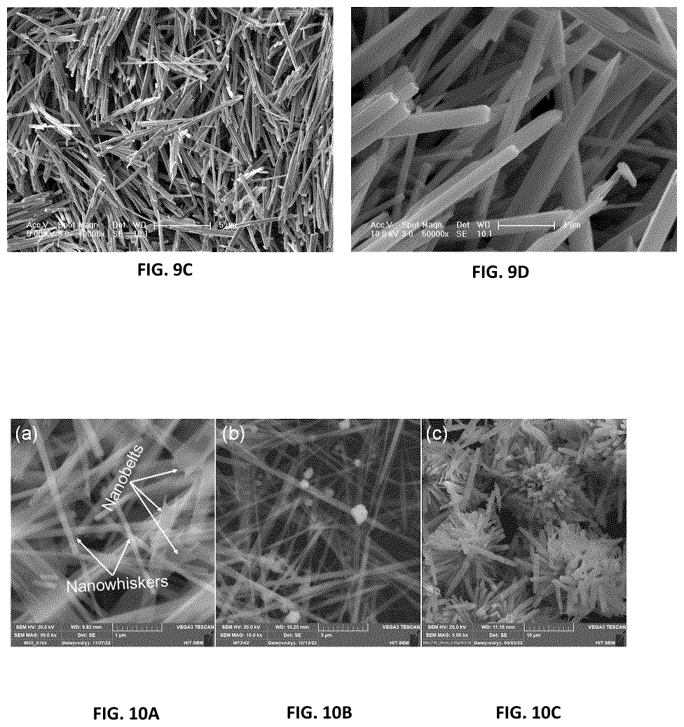

Reference is made to FIGS. 11A to 11D showing the results of linear sweep voltammetry (LSV) measurements performed with different structures of VS₂, WS₂ and MoS₂ (VS₂ tubes, WS₂ tubes, MoS₂ tubes, VS₂ flowers WS₂ triangles and MoS₂ flowers) in acidic (FIGS. 11A and 11B) and alkaline (FIGS. 11C and 11D) media, wherein FIG. 11A shows HER polarization curves in 0.5 M H₂SO₄; FIG. 11B shows corresponding Tafel plots obtained from the polarization curves of FIG. 11A; FIG. 11C shows HER polarization curves in 0.5 M KOH; and FIG. 11D shows corresponding Tafel plots obtained from the polarization curves of FIG. 11C. Table 1 summarizes the electrochemical HER activity of the various VS₂, WS₂ and MoS₂ structures.

TABLE 1

| | Over Potential | | | | R_{ct} from | | |
|---|---|---|---|---|---|---|---|
| | at 10 mA/cm² | | Tafel slope | | Impedance at | | |
| | (mV) | | (mV/dec) | | 400 mV (Ω) | | ECSA |
| Catalyst | Acid | Base | Acid | Base | Acid | Base | (cm²) |
| MoS₂ nanotubes | −0.223 | −0.270 | 84 | 139 | 13 | 34 | 276 |
| MoS₂ nanoflowers | −0.239 | −0.260 | 76 | 113 | 17 | 20 | 174 |
| WS₂ nanotubes | −0.355 | −0.381 | 115 | 134 | 102 | 316 | 32 |
| WS₂ nanotriangles | −0.289 | −0.420 | 73 | 179 | 98 | 206 | 154 |
| VS₂ nanotubes | −0.588 | −0.599 | 154 | 174 | 1695 | 2109 | 22 |
| VS₂ nanoflowers | −0.398 | −0.558 | 95 | 129 | 187 | 890 | 37 |

The activity trend is MoS₂>WS₂>VS₂, as seen by the lower overpotential and smaller Tafel slopes. In addition, the MoS₂ nanotubes offer low charge transfer resistance, facilitating the catalytic reaction, as revealed by electrochemical impedance spectroscopy (EIS) measurements. Specifically, the MoS₂ nanotubes, corresponding to the first-type MoS₂ INTs described above, exhibited the highest electrochemical surface area (ECSA), showing that the surface of the nanotubes is strongly activated by both the bending and high density of defects. In contrast, the MoS₂ nanoflowers with their defective surfaces exhibited a lower ECSA, emphasizing the specific contribution of combining defects and crystallinity of the MoS₂ nanotubes on the formation of active sites in the MoS₂ nanotubes. Normalizing the overall activity to the ECSA provides a measure of the intrinsic activity of the catalysts, showing that MoS₂ nanotubes of the first type described in the present disclosure, exhibit a combination of intrinsically active sites with abundance of such sites. The electrocatalytic stability was confirmed by performing continuous 3000 cyclic voltammetry (CV) cycles in 0.5 M H₂SO₄. Overall, all the samples maintained the catalytic activity even after 3000 CV cycles with slight change in nature of the plot. In the case of MoS₂, only slight surface oxidation of the catalyst was noticed.

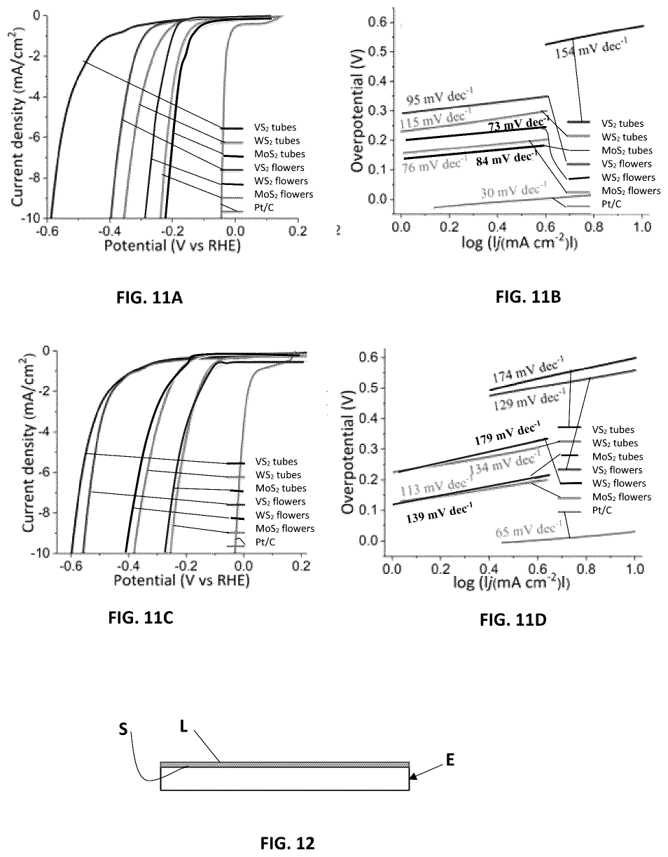

Hence, the type-I MoS₂ INTs of the present disclosure having high density arrangement of active sites therealong (i.e., MoS₂ INTs of the needle-like crystal of hollow core morphology with the walls' structure of randomly oriented nanoplatelets along the longitudinal axis of the MoS₂ INT), can be used to form a chemically active electrode. This is illustrated in FIG. 12: an electrode E (generally, an electrically-conductive substrate) has a surface S carrying (coated by) a layer L of the first-type MoS₂ INTs. The surface S with the MoS₂ INTs thereon is therefore configured and operable as the active surface characterized by enhanced catalytic activity.

1. A method of production of crystalline molybdenum disulfide (MoS₂) inorganic nanotubes (INTs), the method comprising:
performing initial synthesis of pure phase hexagonal molybdenum oxide (h-MoO₃) nanowhiskers, said h-MoO₃ nanowhiskers presenting a precursor and templating agent for producing the MoS₂ INTs;
performing a first-stage sulfurization of the precursor and templating agent, h-MoO₃, via a solid-gas reaction of the h-MoO₃ with reactive gases at first predetermined temperature conditions, said first stage sulfurization comprising partial reduction of h-MoO₃ nanowhiskers to MoOₓ-containing nanowhiskers (2≤x<3), followed by formation of nanostructures corresponding to an initial growth stage of MoS₂ INTs having cores comprising MoOₓ-containing nanowhiskers and initial MoS₂ intermittent guiding layers, configured as randomly oriented nanoplatelets or partially distorted layers, at the surface of the MoOₓ-containing nanowhiskers, such that said MoS₂ intermittent guiding layers provide protection against any one of sublimation or over-reduction of the MoOₓ at higher temperatures;
performing at least a second stage sulfurization of said nanostructures via a solid-gas reaction thereof with reactive gases at second predetermined temperature conditions being relatively high as compared to the first temperature conditions, thereby providing recrystallization of said MoS₂ intermittent guiding layers to obtain highly crystalline layers and complete sulfurization of MoOₓ inside the cores to MoS₂, and to obtain pure phase and high aspect ratio MoS₂ INTs of needle-like crystal with hollow core morphology, and predetermined walls' structure.

2. The synthetic method according to claim 1, wherein said initial synthesis of the pure phase h-MoO₃ nanowhiskers is characterized by at least one of the following: said initial synthesis comprises a chemical precipitation process; said initial synthesis is performed in an oil bath reactor to maintain uniform temperature throughout a reaction time of the initial synthesis with a predetermined amount of double distilled water being heated, to thereby providing uniform temperature condition of the initial synthesis.

3. The synthetic method according to claim 1, characterized by at least one of the following:
said at least second stage sulfurization is applied to different portions of said nanostructures under differently controlled conditions;
a majority of the MoS₂ INTs resulting from the at least second stage sulfurization have an aspect ratio of a value in a range of about 25-1250;
said second predetermined temperature maintained during the second stage sulfurization is 750-820° C. producing a first type of said MoS₂ INTs of the needle-like crystal with hollow core morphology with the walls' structure characterized by the randomly oriented nanoplatelets along a longitudinal axis of the MoS₂ INT, thereby forming a high density arrangement of active sites enabling enhanced catalytic activity.

4. The synthetic method according to claim 3, wherein the MoS₂ INTs resulting from the at least second stage sulfurization have a diameter of about 20-150 nm and a length of up to 15 microns.

5. The synthetic method according to claim 1, wherein said second predetermined temperature maintained during the second stage sulfurization is 750-820° C. producing a first type of said MoS₂ INTs of the needle-like crystal with hollow core morphology with the walls' structure characterized by the randomly oriented nanoplatelets along a longitudinal axis of the MoS₂ INT, thereby forming a high density arrangement of active sites enabling enhanced catalytic activity, said second stage sulfurization being carried out using flows of a reactive gas H₂S and a carrier gas N₂, at predetermined flow rates for a predetermined time period.

6. The synthetic method according to claim 5, wherein said second stage sulfurization is carried out using the flows of the reactive gas H₂S and the carrier gas N₂, at the flow rates of 5-10 ml/min, and 80-100 ml/min, respectively, for the time period of 30-60 min.

7. The synthetic method according to claim 1, wherein said second predetermined temperature maintained during the second stage sulfurization is 750-820° C. producing a first type of said MoS₂ INTs of the needle-like crystal with hollow core morphology with the walls' structure characterized by the randomly oriented nanoplatelets along a longitudinal axis of the MoS₂ INT, thereby forming a high density arrangement of active sites enabling enhanced catalytic activity, said MoS₂ INTs of the first type have the enhanced catalytic activity in electrocatalytic hydrogen evolution reaction (HER).

8. The synthetic method according to claim 7, wherein said second predetermined temperature maintained during the second stage sulfurization is 750-820° C. producing a first type of said MoS₂ INTs of the needle-like crystal with hollow core morphology with the walls' structure characterized by the randomly oriented nanoplatelets along a longitudinal axis of the MoS₂ INT, thereby forming a high density arrangement of active sites enabling enhanced catalytic activity, said method further comprising performing a third sulfurization stage following said second stage, said third sulfurization stage being performed under predetermined third high temperature higher than said temperature of the second stage and using said MoS₂ INTs of the first type as a precursor, thereby producing said MoS₂ INTs of a second type having the needle-like crystal and hollow core morphology having the walls' structure characterized by highly crystalline continual MoS₂ layers substantially parallel to a longitudinal axis of the INT.

9. The synthetic method according to claim 8, characterized by at least one of the following:
said predetermined third high temperature is about 950° C.;
said third sulfurization is carried out using flows of H₂S, H₂ and N₂ gases, at predetermined flow rates for a predetermined time period producing said MoS₂ INTs of the second type;
said MoS₂ INTs are operable as optically or electrically active elements.

10. The synthetic method according to claim 8, wherein said third sulfurization is carried out using flows of H₂S, H₂ and N₂ gases, at predetermined flow rates for a predetermined time period producing said MoS₂ INTs of the second type, said third sulfurization stage being carried out using the flows of H₂S, H₂ and N₂ gases, at the flow rates of 5-10 ml/min, 5-10 ml/min and 80-100 ml/min, respectively, for the time period of 30-60 min.

11. The synthetic method according to claim 3, wherein said initial synthesis comprises: (i) heating the double distilled water to provide a reaction temperature of about 75-80° C. in said oil bath reactor; (ii) adding ammonium molybdate tetrahydrate ((NH₄)₆Mo₇O₂₄·4H₂O) and sodium dodecyl sulphate (CH₃(CH₂)₁₁OSO₃Na) and stirring a mixture; (iii) adding, to said mixture, nitric acid (HNO₃) in a dropwise fashion at a predetermined drop rate to ensure uniform dropping, thereby obtaining a reaction solution; (iv) stirring the reaction solution to obtain a white milky precipitate, thereby enabling to obtain a clean precipitate of pure phase h-MoO₃ nanowhiskers.

12. The synthetic method according to claim 11, characterized by at least one of the following:
said double distilled water in the oil bath reactor is in amount of 8-12 ml;
said ammonium molybdate tetrahydrate ((NH₄)₆Mo₇O₂₄·4H₂O) being added is in amount of about 0.57-0.63 g, and said sodium dodecyl sulphate (CH₃(CH₂)₁₁OSO₃Na) being added is in amount of about 0.32-0.36 g;
said mixture is stirring for about 10-15 min;
said nitric acid (HNO₃) being added is 69%-concentrated nitric acid (HNO₃) in amount of about 18-22 ml;
said stirring of the reaction solution is during a time period of about 15-30 min;
a majority of said pure phase h-MoO₃ nanowhiskers have an aspect ratio of up to 1250.

13. The synthetic method according to claim 11, wherein said nitric acid (HNO₃) being added is 69%-concentrated nitric acid (HNO₃) in amount of about 18-22 ml, the drop rate being about 2.4 ml/min.

14. The synthetic method according to claim 13, wherein said adding in the dropwise fashion to ensure uniform dropping comprises use of an automated syringe pump controller.

15. The synthetic method according to claim 11, wherein a majority of said pure phase h-MoO₃ nanowhiskers have an aspect ratio of up to 1250, a diameter of 20-150 nm, and a length of up to 25 microns.

16. The synthetic method according to claim 1, characterized by at least one of the following:
said first predetermined temperature is in a range of about 380-400° C.;
said first stage sulfurization of h-MoO₃ comprises:
the partial reduction of h-MoO₃ to MoOₓ comprising interacting the h-MoO₃ with flows of the reducing gas H₂ and carrier gas N₂ at 5-20 ml/min and 100 ml/min flow rates, respectively, for about 10-20 min, to produce the MoOₓ-containing nanowhiskers being MoOₓ/MoO₃ nanowhiskers comprising a mixture of MoOₓ suboxide phases and MoO₃; and
interaction of the MoOₓ/MoO₃ nanowhiskers with flows of the reactive gases H₂S and H₂ and carrier gas N₂, at flow rates of 5-10 ml/min, 5-20 ml/min, and 100 ml/min, respectively, for a time period of 30-60 min, to thereby produce said nanostructures comprising said initial MoS₂ intermittent guiding layers on the surface of the MoOₓ/MoO₃ nanowhiskers such that said mixture of suboxide phases comprising Mo₄O₁₁, Mo₈O₂₃ and MoO₂, is located inside the core of said MoS₂ INTs at the initial stage of their growth, and said MoS₂ intermittent guiding layers are located on the surface of the MoOₓ/MoO₃ nanowhiskers providing protection against any one of sublimation or over-reduction of MoOₓ core at higher temperatures.

17. A product configured as a precursor and a templating agent for producing therefrom highly crystalline molybdenum disulfide (MoS₂) inorganic nanotubes (INTs) via at least two successive stages of sulfurization, said product comprising pure phase hexagonal molybdenum oxide (h-MoO₃) nanowhiskers having an aspect ratio of up to 1250.

18. A product comprising molybdenum disulfide (MoS₂) inorganic nanotubes (INTs) having needle-like crystal with hollow core morphology and walls' structure, said walls structure having one of the following configurations: characterized by randomly oriented nanoplatelets along a longitudinal axis of the MoS₂ INT, defining a high density arrangement of active sites enabling enhanced catalytic activity; and comprising highly crystalline continual MoS₂ layers substantially parallel to a longitudinal axis of the INT.

19. A product configured as a templating agent for producing therefrom highly crystalline molybdenum disulfide (MoS₂) inorganic nanotubes (INTs) via two successive stages of sulfurization, said product being produced by the synthetic method according to claim 11 and comprising pure phase hexagonal molybdenum oxide (h-MoO₃) nanowhiskers having an aspect ratio of up to 1250.

20. A product comprising molybdenum disulfide (MoS₂) inorganic nanotubes (INTs) produced by the synthetic method according to claim 1, said MoS₂ INTs having needle-like crystal with hollow core morphology and walls' structure, said walls' structure having one of the following configurations: characterized by randomly oriented nanoplatelets along a longitudinal axis of the MoS₂ INT, defining a high-density arrangement of active sites enabling enhanced catalytic activity; and characterized by highly crystalline continual MoS₂ layers substantially parallel to a longitudinal axis of the INT.

21. A chemically active electrode comprising: an electrically conductive substrate having a surface carrying the product of claim 18, where the walls' structure of the product is characterized by randomly oriented nanoplatelets along a longitudinal axis of the MoS₂ INT, defining a high density arrangement of active sites enabling enhanced catalytic activity.

22. An optical or electro-optical device comprising the product according to claim 18, where the walls' structure of the product is characterized by the highly crystalline continual MoS₂ layers substantially parallel to a longitudinal axis of the TNT.
